(19) United States
(12) Patent Application Publication
(10) Pub. No.: US 2026/0299969 A1
(43) Pub. Date: Oct. 1, 2026

(54) FRONTEND FUNCTION FRAMEWORK FOR ARTIFICIAL INTELLIGENCE (AI) ASSISTANT

(71) Applicant: SAP SE, Walldorf (DE)

(72) Inventors: Christian GRAIL, Zuzenhausen (DE); Christian DENKEL, Johlingen (DE)

(21) Appl. No.: 19/089,350

(22) Filed: Mar. 25, 2025

(51) Int. Cl. G06F 9/451; G06F 40/40

(52) U.S. Cl. CPC G06F 9/451; G06F 40/40

(57) ABSTRACT

According to some embodiments, systems and methods are provided including a memory storing program code: and one or more processing units to execute the program code to cause the system to: receive a request at an Artificial Intelligence (AI) assistant, the request received from a user of a remote device via a distributed communication network; receive, from an application associated with the request, a list of one or more frontend functions; select an AI Assistant capability based on the received request and the received list of one or more frontend functions; generate, by the AI Assistant, an executable command including a listed frontend function for the application based on the selected AI Assistant capability and the received request; and execute the executable command in response to receipt of the executable command by the application. Numerous other aspects are provided.

### BACKGROUND

An Artificial Intelligence (AI) assistant is a software program that uses artificial intelligence to understand voice and other commands and perform tasks for a user. The AI Assistant can understand voice commands, read text, make calls, etc. The AI Assistant may use natural language processing to understand voice and written commands. Additionally, the AI Assistant may be integrated with other applications and services. For example, an enterprise may use an AI Assistant to pull relevant data directly from a given source in response to natural language queries. Often the AI Assistant used by enterprises may access a backend server via backend HTTP requests to perform data processing and analysis to provide meaningful insights based on the user's query and context. Many of the user queries are independent of any application currently running alongside the AI Assistant. As a non-exhaustive example, a user may be running an application that generates an Aging Report, and the user asks the AI Assistant to summarize the Aging Report. Often the AI Assistant will not be able to summarize the Aging Report because it does not have access to the application generating the Aging Report, nor the Aging Report itself.

Systems and methods are desired to facilitate user interaction with an AI Assistant and application.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of an architecture according to some embodiments.

FIG. 2 is a flow diagram of a process according to some embodiments.

FIG. 3 is a non-exhaustive example of a user interface including a user query according to some embodiments.

FIG. 4 is a sequence diagram illustrating generation of an answer to a user query according to some embodiments.

FIG. 5A is another sequence diagram illustrating generation of an answer to a user query according to some embodiments.

FIG. 5B is a continuation of the sequence diagram of FIG. 5A according to some embodiments.

FIG. 6 is a non-exhaustive example of a user interface including the user query of FIGS. 5A and 5B according to some embodiments.

FIG. 7 is a continuation of FIG. 6 including an answer to the user query according to some embodiments.

FIG. 8 is a block diagram of a hardware environment providing generation of a frontend response from an Artificial Intelligence (AI) assistant according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

As described above, an AI Assistant (e.g., Joule® from SAP), works by querying and modifying data via backend requests. The AI Assistant is able to retrieve data from an enterprise system, display it in an AIA Web Client and also modify, create, and delete data in the backend system. Functionality is added to the AI Assistant by providing AI Assistant backend functions. Non-exhaustive examples of these functions are booking time off, booking a flight, creating a purchase order, etc. These functions can communicate with an application via backend HTTP requests. However, the functions are independent of the application running alongside the AI Assistant (e.g., the above-mentioned Aging Report).

In some cases, the AI Assistant may be aware of the application running alongside it. It is noted that while in some instances, a specific AI Assistant function may be added for an application (e.g., via a Summarize button), it may not be desirable to add buttons for every possible capability on every page. Additionally, for each task (e.g., function) asked of the AI Assistant, a service (e.g., REST service or OData service) is used for the interaction-via an Application Programming Interface (API)—between the AI Assistant and the backend system. Applications like Graphical User Interface (GUI) applications and Web applications (e.g., SAP's GUI for HTML or Web Dynpro) often lack OData services or other forms of HTTP-based Application Programming Interfaces (APIs), which are required for access to the enterprise backend and seamless integration with the AI Assistant. As such, there are a lot of possible tasks (e.g., functionality) that could be available for a traditional application, but are not accessible to the AI Assistant.

Further, because the interactions between the AI Assistant and enterprise applications occur via backend requests, this presents disadvantages including, but not limited to, different states between the frontend and the backend, the required communication setup and different user sessions.

To address these problems, a Frontend Function (FF) framework or system provides for the movement of some of those traditional backend functions to the frontend. Embodiments provide for the AI Assistant to speak through the application, interact with the application, and perform actions based on the user interactions. Embodiments provide for the AI Assistant to control the currently running application through clearly defined interfaces. Frontend functions provided by embodiments are application/UI framework specific and enable UI frameworks to expose functionality like refreshing/reloading data, applying filters/sorting/drill-downs of tables/lists in the application, or enabling application developers to expose application specific logic (e.g., assign Freight to truck, decline purchase order, accept leave request, etc.). Embodiments provide for the definition and implementation of a protocol between the application frontend functionality, an AI Assistant (including an AIA Web Client and an AI Assistant backend) and AI Assistant capabilities such that the AI Assistant controls the frontend functions of the application. Pursuant to embodiments, a request (e.g., a voice or text request to an AI Assistant) together with a list of application-specific frontend functions are passed to the AI Assistant backend. The AI Assistant backend selects and calls the AI Assistant (AIA) capability. The AIA capability is something the AI Assistant can do and contains a description for a Large Language Model (LLM) of what it does, what the required parameters are, and which AI Assistant functions are linked to the AIA capability. Depending on the request and application-specific frontend functions, the AI Assistant selects one of a frontend function or a backend function for invocation via a frontend function call or a backend function call, respectively. In the case of invocation of the frontend function, the AI Assistant backend instructs, via an executable command provided by the LLM, the AI Assistant frontend to invoke the frontend function. In response to receipt of the instruction, the AI Assistant frontend forwards the executable command calling the application specific frontend function to the currently running application, and the currently running application then executes this function.

Because frontend functions are executed in a user interface (UI) for a UI application, they run in the same user session of the Browser for the UI application as the AI Assistant running alongside it. An advantage of embodiments is that the permissions/rights of using the AI Assistant are the same as the user has while interacting with the user interface application. Embodiments also provide for no locked entities/objects because frontend functions operate on data which is up to date and visible on the screen. For example, frontend functions like refresh/reload/navigate are used by applications if data is updated in the backend and the updated data needs to be shown to the user on a UI. In the conventional refreshed/reloaded/navigated to data instance, a call is made to the backend, which in turn calls into the enterprise system to retrieve the data and provide it to the UI. The backend call into the enterprise system is a different session than the user interacting with the UI. Due to the disparate sessions, the sessions may be in conflict (e.g., data that has been entered already in the user interface may not yet be saved in the backend). As a non-exhaustive example, suppose there is a list of objects on the UI, and the user tells the AI Assistant to please delete one of them. Conventionally, the AI Assistant deletes the item in the backend, but that deletion is not visible on the UI (frontend) until the user refreshes the screen. Pursuant to one or more embodiments, on the other hand, deleting the object via a frontend function has the immediate result of the object no longer being present on the UI in addition to being deleted from the backend, without waiting for a screen refresh. By having the same session, there is no conflict and the changes on the screen are directly consumable.

Additionally, by offloading frontend functions to the frontend function framework of one or more embodiments, as opposed to the conventional frontend/backend capability, the user is given the opportunity to only be semi-connected to a backend to receive an answer to a request, allowing for implementation using processors of relatively low complexity and improving the functioning of a computer.

Embodiments also simplify the setup and functioning of a computer because no additional backend connectivity needs to be established between the AI Assistant and the enterprise resource planning application. For legacy applications, frontend functions may enable them to be already integrated with the AI Assistant, while new backend services are developed and are ready for consumption.

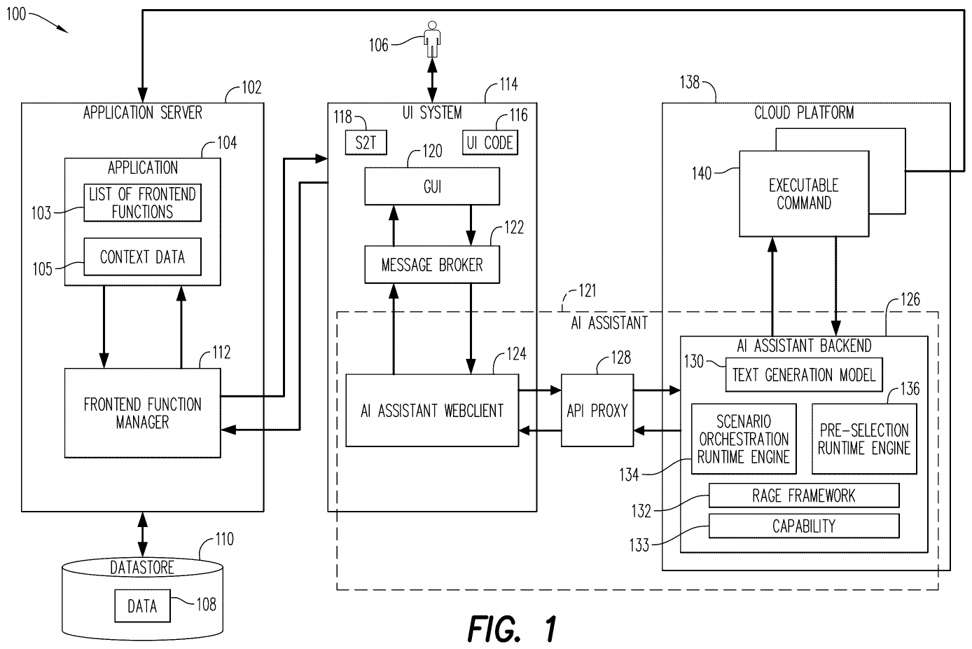

FIG. 1 is a high-level block diagram of a frontend function framework or system architecture 100 according to some embodiments. Embodiments are not limited to architecture.

The illustrated elements of system architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. One or more elements of system architecture 100 may be implemented using any suitable combination of on-premise, cloud-based, distributed (e.g., including distributed storage and/or compute nodes) computing hardware and/or software that is or becomes known. Each computing system described herein may comprise one or more physical and/or virtualized servers.

In some embodiments, two or more elements of system architecture 100 are implemented by a single computing device, and/or two or more elements of system architecture 100 are co-located. One or more components may be implemented as a cloud service (e.g., Software-as-a-Service, Platform-as-a-Service). A cloud-based implementation of any element of FIG. 1 may apportion computing resources elastically according to demand, need, price and/or any other metric.

Application server 102 may comprise one or more servers, virtual machines, etc. Application server 102 may provide an operating system, services, I/O, storage, libraries, frameworks, etc. to applications executing thereon.

Application 104 may comprise program code executable by a processing unit to provide functions to users such as user 106 based on coded logic and on data 108 stored in data store 110. Data 108 may comprise tabular data stored in a columnar or row-based format, object data or any other type of data that is or becomes known. Data store 110 may comprise any suitable storage system such as a database system, which may be partially or fully remote from application server 102, and may be distributed as is known in the art.

Frontend Function (FF) manager 112 may comprise program code executable by application server 102 to operate as described herein. Frontend Function Manager 112 is associated with the configuration and management of the user interface elements and frontend functions within applications. The Frontend Function Manager 112 may control which functions and data users can access within the frontend, as well as transmit the call for execution of the frontend function to the application 104. The Frontend Function Manager 112 may receive a list of frontend functions 103 executable by the application 104. The Frontend Function Manager 112 then provides these functions to an AI Assistant (AIA) Web Client 124 through a Message Broker 122 once a user submits a request to the AIA Web Client 124, as described further below. In one or more embodiments, the Frontend Function Manager 112 requests, and then receives, the list of frontend functions 103 from the running application 104 once the user request is received by the AIA Web Client 124.

A User Interface (UI) system 114 may act as the entry point for accessing various applications through a web browser (e.g., via URL). The UI system 114 may comprise a user device including, but not limited to, a laptop computer, a desktop computer, a smartphone, and a tablet computer. UI system 114 includes one or more processing units to execute User Interface (UI) program code 116 and speech-to-text component 118. UI system 114 may also include a graphical user interface (GUI) 120, a Message Broker 122 and an AIA Web Client 124.

Data from the running application 104 may be rendered on the GUI 120. Running alongside the application 104 is the AIA Web Client 124, which includes a user interface that is also rendered on the GUI 120. An AI Assistant 121 includes both a frontend and backend. The AI Assistant frontend may be the user interface. Here, the AI Assistant frontend is the AIA Web Client 124, which provides an interface on a Web browser and is used to access the AI Assistant backend 126.

The AI Assistant 121 is a virtual assistant that operates within a web interface. The AI Assistant 121 is a software application accessible through a Web browser that utilizes AI to provide users with assistance and information by simulating a human-like interaction, guiding users through processes, providing recommendations, and performing tasks based on user input, all within the context of a website. The AI Assistant 121 uses natural language processing (NLP) to understand natural language queries and respond in a conversational manner. The AIA Web Client 124 appears as a chat window or interactive widget embedded on an Enterprise Resource Planning (ERP) webpage alongside a running application 104 or other suitable webpage. The AIA Web Client 124 is integrated with the running application 104, as described further below.

The UI program code 116 may provide, via the GUI 120, the AIA Web Client 124, a Web browser or another application (e.g., application 104) providing user interfaces for interacting with the user 106.

The AIA Web Client 124 may comprise a frontend UI application corresponding to, and communicating with, the AI Assistant backend 126 (executing within a virtual machine of a cloud platform 138) to present user interfaces thereof. User 106 may interact with such a user interface of AIA Web Client 124 (e.g., using a keyboard, microphone and/or pointing device of UI system 114) to input a natural language query (e.g., “Show me sales in July”) for submission to the AI Assistant backend 126. According to some embodiments, user 106 speaks a natural language query, which is detected by a microphone of UI system 114, converted to text by speech-to-text component 118 and used to populate a user interface of the AIA Web Client 124. According to other embodiments, user 106 types a natural language query into a user interface of the AIA Web Client 124 to populate the user interface of the AIA Web Client 124.

As described further below, the AIA Web Client 124 retrieves context data 105 from the current application running alongside the AIA Web Client 124. In particular, the AI Assistant function uses a program code to extract the context data 105. The context data 105 includes application information, which is information about the current application transaction. The context data 105 provides information to the AIA Web Client 124, and in turn the AI Assistant backend 126, to give a user help with the running application. The context data 105 includes one or more properties including, but not limited to, a framework (e.g., GUI, WDA, CRM), a title (e.g., Edit Purchase Order 4711), transaction identifier, GUI screen, GUI screen number, etc. The context data 105 is used, as a non-exhaustive example, to narrow down the relevant documents available by the current running application. In this example, the query is “Can you help me” and the AI Assistant would know from the context data 105 that the user is currently working on the application having a particular transaction identifier and title. Then, using the context data 105, an AI Assistant function can access the UI technology, the application title, the support component and the technical component side of the application running alongside the AIA Web Client 124.

The AIA Web Client 124 also retrieves, via the Frontend Function Manager 112, a list of frontend functions 103 from the current application running alongside the AIA Web Client 124.

The Message Broker 122 is a system that acts as a secure intermediary to route messages between the GUI 120 and the AIA Web Client 124. The Message Broker 122 acts as a central hub for managing communications and data exchange between different applications, allowing them to interact with each other seamlessly by sending and receiving messages in a standardized format, facilitating smooth data flow across various applications. The Message Broker 122 enables real-time updates and data synchronization between different applications.

AIA Web Client 124 forwards the received user query along with the context data 105 and list of frontend functions 103 to AI Assistant backend 126 via Application Programming Interface (API) proxy 128, or other suitable interface, and a respective API. The AI Assistant backend 126 comprises a server-side infrastructure that powers the AI Assistant, handling the core logic, data processing and communication with the AIA Web Client 124. The AI Assistant backend 126 determines an AI Assistant backend function (e.g., included in an AIA capability) that can handle the query and invokes it. The AIA capability is selected, in part, based on the current running application included in the context data. The AIA capability is designed to know which fields should be populated with specific values in order to fulfill the user prompt (request).

The AI Assistant backend 126 includes a trained text generation model 130. The trained text generation model 130 receives the user query and the list of frontend functions 103.

Text generation model 130 may comprise a neural network trained to generate text based on input text. Text generation model 130 may be implemented by, for example, executable program code, a set of hyperparameters defining a model structure and a set of corresponding weights, or any other representation of an input-to-output mapping which was learned as a result of the training. According to some embodiments, model 130 is a Large Language Model (LLM) conforming to a transformer architecture. LLMs are a specific type of machine learning model focusing on generating human-like text and understanding complex language patterns. LLMs are trained from large datasets of text to identify patterns and improve their ability to process and generate language. A transformer architecture is a deep learning technique and may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 130 include GPT-4, LaMDA, Claude or the like. Model 130 may be publicly available or deployed within a trusted landscape. Similarly, text generation model 130 may be trained based on public and/or private data. According to some embodiments, model 130 is pre-trained with information to improve the quality of its responses to user queries.

Prior to receipt of the user request, all available frontend functions that may be provided by any running application integrated with the AI Assistant are, pursuant to embodiments, modeled as AIA capabilities. An AIA capability 133 is something that the AI Assistant 121 can do. The AIA capability 133 includes a description for the text generation model 130 of what it does, what the required parameters are, and which AI Assistant functions are linked to the AIA capability 133. The AI Assistant can either call a backend of the application (e.g., via a backend REST request) to generate a response to the request or call a frontend of the application (via the AIA Web Client). With respect to the frontend call, the AI Assistant instructs the AIA Web Client to call the frontend function of the application via the Message Broker 122. Invocation of the frontend function call at the running application occurs via execution of a technical OK code (% gs . . . ) which calls the corresponding (e.g., mapped) frontend functionality the application provided to the Frontend Function Manager 112 in the list of frontend functions 103.

Pursuant to embodiments, the running application frontend function calls may be either uni-directional where the AI Assistant doesn't expect or wait for a response or bi-directional where the AI Assistant expects a response, which when received is then sent to the AI Assistant backend 126 with the next request. For example, for some instances it is necessary that the running application can return a response for the AI Assistant backend or a response for the user. To address these instances, the Web Client API includes a “sendResponse” method enabling running applications to send a response from the running application to the AIA Web Client. The response may be a message type including, but not limited to, client_data for data which needs to be processed by an AI Assistant backend function, a text message for plain text response, a card, a list, etc.

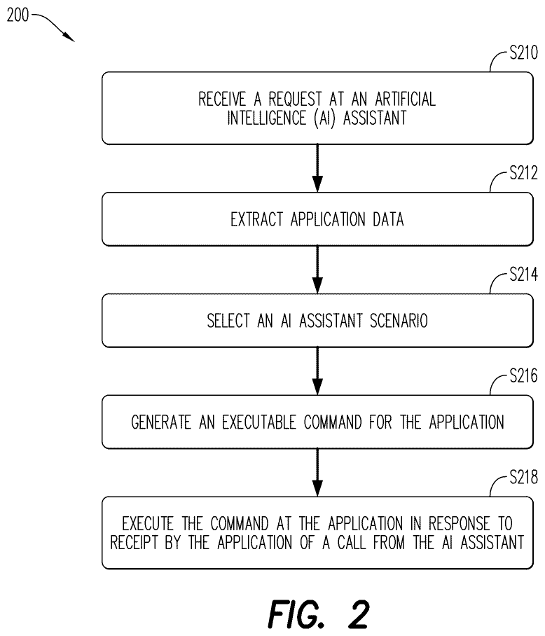

The AI Assistant backend 126 further includes a Retrieval-Augmented Generation with Explanation (RAGE) framework 132. The RAGE framework 132 combines information retrieval with the text generation model for generating responses and also provides detailed explanations about how the framework 132 arrived at that answer. The AIA capabilities 133 are stored in the RAGE framework 132. The RAGE framework 132 analyzes vectors representing the capabilities and data of a knowledge base including at least internal enterprise data and databases and identifies any relevant data from the knowledge base. This analysis is used in selection of an AIA capability, as described further below with respect to FIG. 2.

Prior to selection of the AIA capability, the AI Assistant backend 126 receives the user request and the list of one or more frontend functions 103 provided by the running application 104. In a case a given capability is selected, the AI Assistant calls the running application to execute the application-specific frontend function mapped to the AI Assistant function included in the selected capability. The function call executes the function (e.g., code) at the currently running application, allowing the use of the functionality defined within that function at the point where it is called (e.g., the function is invoked to perform a specific task or condition). In one or more embodiments, the frontend function calls corresponding to the application-specific frontend functions are added to an AI Assistant response schema.

In some instances, following execution of the frontend function by the running application, the output of the execution of the frontend function is passed back to the AI Assistant. The AI Assistant then uses the text generation tool to generate a response for the user and a Dialog Management tool to aid in delivery of the generated response to the user, as described further below.

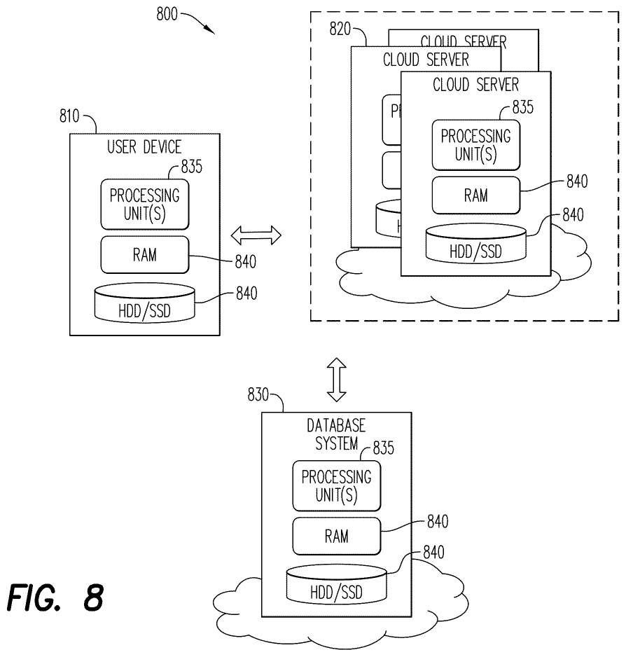

FIG. 2 illustrates a process 200 to integrate a running application with an AI Assistant according to some embodiments. The process 200, and other processes described herein, may be performed by a database node, a cloud platform, a server, a computing system (user device), a combination of devices/nodes, or the like, according to some embodiments. In one or more embodiments, the system architecture 100 may be conditioned to perform the process 200, and other processes described herein, such that a processing unit 835 (FIG. 8) of the system architecture 100 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

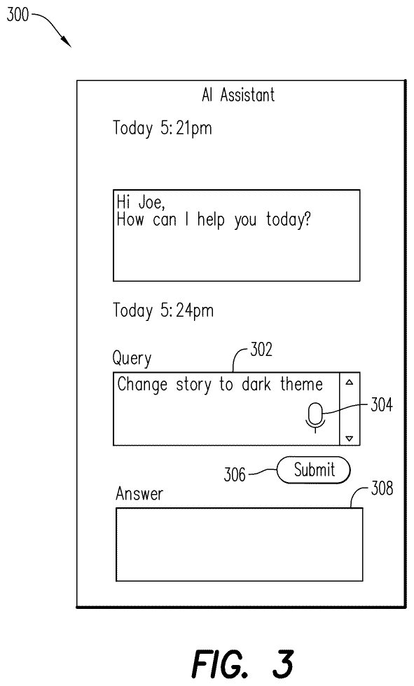

Prior to execution of the process 200, a user 106 accesses and interacts with an application 104 via GUI 120. The AI Assistant 121 is initiated by the application 104 (e.g., automatically) or via selection of an AI Assistant icon, etc. Initiation of the AI Assistant 121 provides the AIA Web Client user interface 300 (FIG. 3). The AIA Web Client user interface 300 may be returned alongside the application 104 rendered on the GUI 120.

A natural language request (query) is received at S210. The natural language request is received from a user of a remote device via a distributed communication network. The natural language query may be created by a user in any suitable manner. A user may, for example, input the natural language query into the AIA Web Client user interface 300 and instruct the AI Assistant to answer the query. The query may be input via typing, speaking, or other suitable input.

FIG. 3 illustrates an AIA Web Client user interface 300 of an AI Assistant according to some embodiments. Area 302 receives a natural language query, via typing, speech, etc. For example, user selection of icon 304 initiates speech-to-text functionality for populating area 302 using speech. Submit control 306 is selected to transmit the query to the AI Assistant backend 126. Following execution of the AI Assistant 121, according to embodiments, an answer to the user query of area 302 is presented in area 308 and/or in the running application user interface itself. Embodiments may thereby allow a user to efficiently receive desired information from a data source and/or perform actions in an application via the AI Assistant 121.

Then in S212, the AI Assistant 121 extracts application context data 105 from the application 104. In response to selection of the Submit control 306, the AIA Web Client 124 transmits an application context data request, via the Message Broker 122, to the FF Manager 112 to retrieve application context data 105 including a list of application-specific frontend functions from the application 104. Pursuant to some embodiments, the application context data request may be transmitted from the Message Broker 122 to the FF Manager 112 via the GUI 120. In order for the AI Assistant 121 to provide a user with help with a running application, the AI Assistant 121 extracts application context data 105 about the current running application via an AI Assistant function. The application context data 105 includes, but is not limited to, an application framework (e.g., GUI, WDA, CRM, etc.), a title (e.g., Edit Purchase Order 4711, Display users), a transaction identifier that may be used to query help for a current transaction, a GUI screen identifier that may provide screen specific answers, and a GUI screen number that may provide screen detail specific answers. The application context data 105 also includes a list of one or more application-specific frontend functions 103. The application-specific frontend functions are functions provided by the current running application that may be called by the AI Assistant. Non-exhaustive examples of application-specific frontend functions are: refresh/reload data (e.g., an AI Assistant backend function has modified a Purchase Order and wants the user to see the modified data); navigate to a section/tab/sub-screen of the current application or a different application (e.g., in a case the user doesn't find information in a complex application, the AI Assistant can point to the part of the application where the information is available); fill (populate) data/fields/input elements or select data on a screen (e.g., the AI Assistant can provide a guided help for filling out complex screens/how to enter data correctly); filter data in a list/table/chart which is currently displayed in the application; get (retrieve/aggregate/summarize) content and/or retrieve selected data (e.g., the AI Assistant creates a summary of what is visible on the screen). The LLM needs the data a user currently sees to be able to summarize that content, and depending on the use case, the data displayed on the screen may be different from the data available on the backend); and get selected entries in a table or list (e.g., select people in a list and ask the AI Assistant to provide a summary of those people), etc. The identity of the application-specific frontend functions may be included in the application context data 105 as a property with the name “client_functions” or any other suitable name. The list of frontend functions may be retrieved via a “getClientFunctions” request as part of application context data request. Pursuant to embodiments, integration of the AI Assistant 121 with the application 104 provides for the AI Assistant function to access the application context data 105 of the running application 104 via a code. For example, the AI Assistant function accesses the UI technology of the application running next to the AI Assistant, the application title, the support component and the technical component id, where in some instances the technical component id is the transaction code for a GUI for HTML applications. Pursuant to embodiments, each time a user request is received by the AIA Web Client, the AIA Web Client 124 requests the application context data.

Then, at S214, an AI Assistant capability 133 is selected. The AI Assistant capability 133 is selected based on the received user request and the received list of one or more frontend functions 103. As described above, the AI Assistant capability (e.g., scenario) 133 contains a description of what the capability does, what the required parameters are, and which AI Assistant functions are linked to the capability. As used herein, the terms “capability” and “scenario” may be used interchangeably. The AI Assistant functions call the application-specific frontend functions, where a given AI Assistant function is mapped to an application-specific frontend function. The AI Assistant capability 133 is designed to know which fields should be populated with specific values to fulfill the user request. As a non-exhaustive example, an AI Assistant capability 133 is a filter, with the capability description as “selects or highlights specific parts of a dataset”, the required parameters as “field name” and “field value,” and the AI Assistant function as “filter”.

Regarding selection of the AIA capability 133, the RAGE framework 132 uses vectors representing capabilities and data of the knowledge base along with the list of frontend functions 103 to restrict all available frontend functions/capabilities to a list of currently available capabilities (“list of capabilities”) for this request. The knowledge base stores additional data beyond data used to train the text generation model 130. The RAGE framework 132 returns the list of capabilities to a Scenario Orchestration runtime engine 134 via a scenario/capability pre-selection runtime engine 136. The Scenario Orchestration runtime engine 134 selects the capability from the list of capabilities via determination the requested functionality, per the user request, maps to the function included in the selected capability. The Scenario Orchestration runtime engine 134 receives the selected capability including the AI Assistant frontend function identifiers from the RAGE framework 132.

Following selection of the capability, in S216 the text generation model 130 generates an executable command 140 for the application 104. The executable command 140 includes a function call for the function included in the selected capability and values for the parameters. The text generation model 130 of the AI Assistant backend 126 receives the user request and the selected capability. As described above, the AI Assistant capability contains a description for the text generation model 130 of what it does, what the required parameters are, and which AI Assistant function is linked thereto. Continuing with the non-exhaustive filter example, the capability includes a field name parameter and a field value parameter. Based on the user request and the selected AI Assistant capability as received input to the text generation model, the text generation model 130 determines the user wants to filter something and detects a field name and a field value in the request. The text generation model 130 then generates an executable command including a function call for the function with the name “filter” and parameters including a parameter (e.g., column) name (e.g. “month”) and a parameter value (e.g., “July”) as included in the request.

Next, in S218, the executable command 140 is executed. The executable command 140 including the frontend function call is returned to the running application 104, where it is invoked. In one or more embodiments, a property of the AI Assistant message schema may be used to transfer data from the AI Assistant backend to the user interface which is not displayed directly. In some embodiments, the executable command including the frontend function call is returned via a AI Assistant API to the AIA Web Client 124 and Message Broker 122. The Message Broker 122 checks the response for an AI Assistant Frontend Function call and when found, passes this call to the currently running application 104, invoking execution of the frontend function by the application 104. The invocation occurs via technical OK Code (% gs . . . ) which will then call the corresponding application backend functionality that the application previously provided to the FF Manager 112 as part of the list of frontend functions 103. The currently running application 104 executes the frontend function and provides a response to the user visible in at least one of the application user interface and the AIA Web Client.

As described above, the frontend function calls may be either uni-directional where the AI Assistant doesn't expect or wait for a response or bi-directional where the AI Assistant expects a response, which is then sent to the AI Assistant backend 126 with the next request.

With respect to the frontend function of “filter”, conventionally, for a user to filter data in a table, the user performs a plurality of steps including, but not limited to, selecting a parameter to filter on, moving the parameter to a different part of the user interface, selecting the “define a new filter” control, setting a value for the parameter, moving further data, and selecting an “apply” control. Pursuant to embodiments, due to the integration of the running application and the AI Assistant, the user simply submits a query that says “filter by value X” and then this request is processed as described above with respect to S212-S218, and the result is visibly displayed. It is noted that this non-exhaustive example of filtering with one parameter is a relatively simple example, and more complicated filtering requests, including many more criteria and/or selections, may also be executed as described herein.

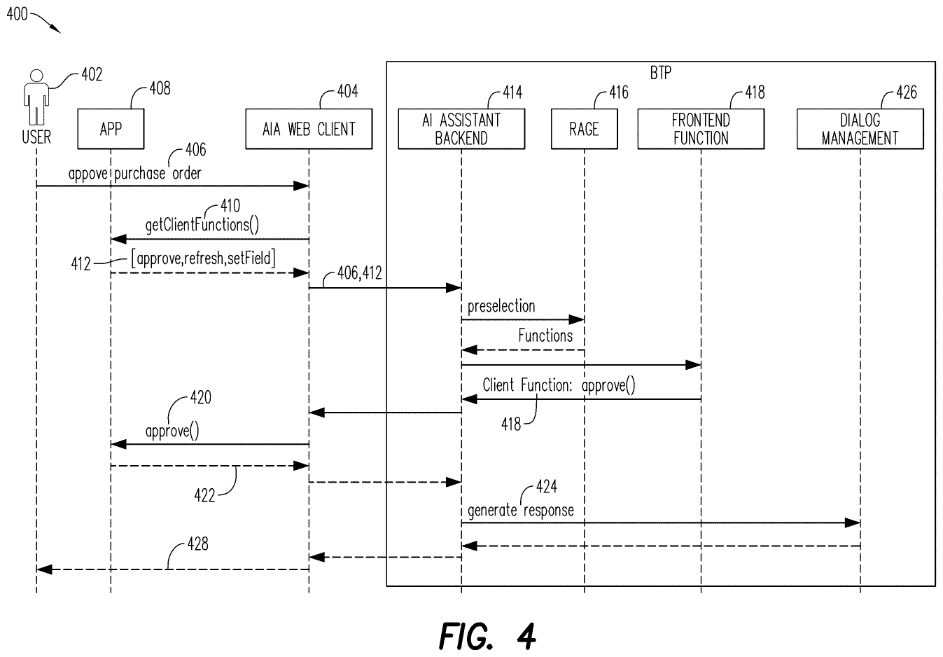

FIG. 4 is a sequence diagram 400 illustrating a non-exhaustive example of the generation of an answer to a user query to approve a purchase order. As illustrated, user device 402 calls the AIA Web Client 404 with a user query 406. The AIA Web Client 404 then calls the Application (App) 408 to retrieve the client functions (list of frontend functions) with the call “getClientFunctions( )” 410. The Application 408 returns client functions 412 of: approve, refresh and setField to the AIA Web Client 404. The AIA Web Client 404 transmits the client functions 412 and user query 406 to the AI Assistant Backend 414. The AI Assistant Backend 414 transmits the client functions 412 and user query 406 to the RAGE framework 416. The RAGE framework 416 executes a pre-selection process resulting in a limited number of capabilities including AI Assistant frontend functions and ultimately in the selection of a capability including an AI Assistant frontend function identifier corresponding to the “approve” frontend function. The frontend function identifier is returned to the AI Assistant backend 414. The AI Assistant backend 414 executes the text generation model, providing the selected frontend function identifier as input, in part, along with the user request. The executable command is generated, including a call for the running application frontend function “approve” 418 and transmitted at 420 to the application 408 via the AI Assistant Backend 414 and AIA Web Client 404. The application 408 executes the approve executable command via the application backend at 422 and notifies the AI Assistant Backend 414 via the AIA Web Client 404. The AI Assistant Backend 414, using the text generation model, generates a response at 424 based on the information contained in the notification. Based on the notification information that is output from execution of the frontend function at the application, the AI Assistant Backend 414 generates a language dependent answer to the query. It is noted that the application does not have to return a written text, but may actually just return parameters, and the AI Assistant Backend 414 generates a user-readable text using the text generation model. The generated response is transmitted to the Dialog Management tool 426, which transmits a command, via the AI Assistant Backend 414 and AIA Web Client 404 to pause execution of the application and render the generated response at the user device 402 at 428.

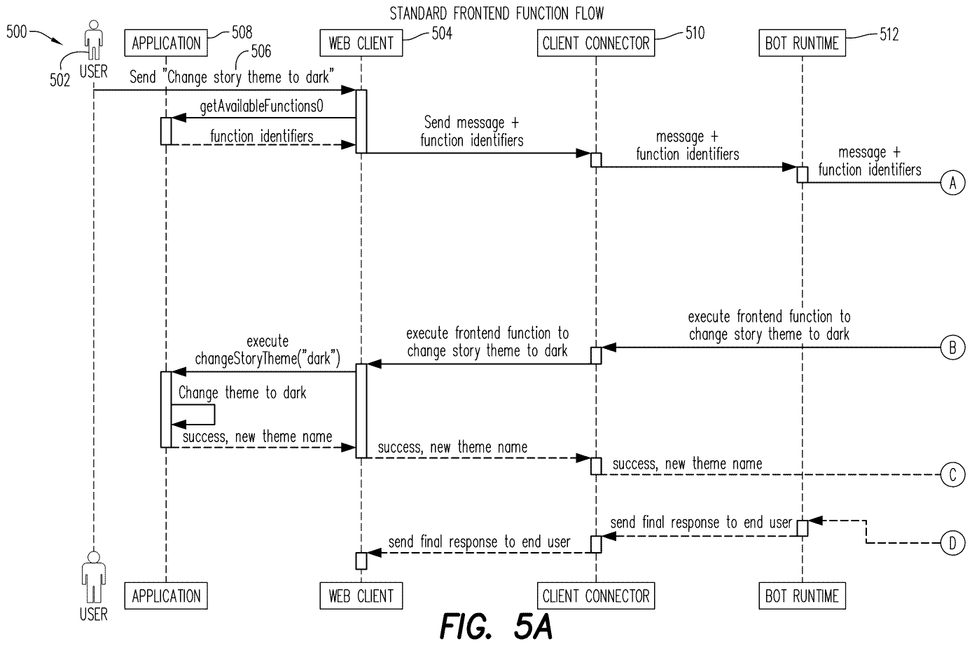

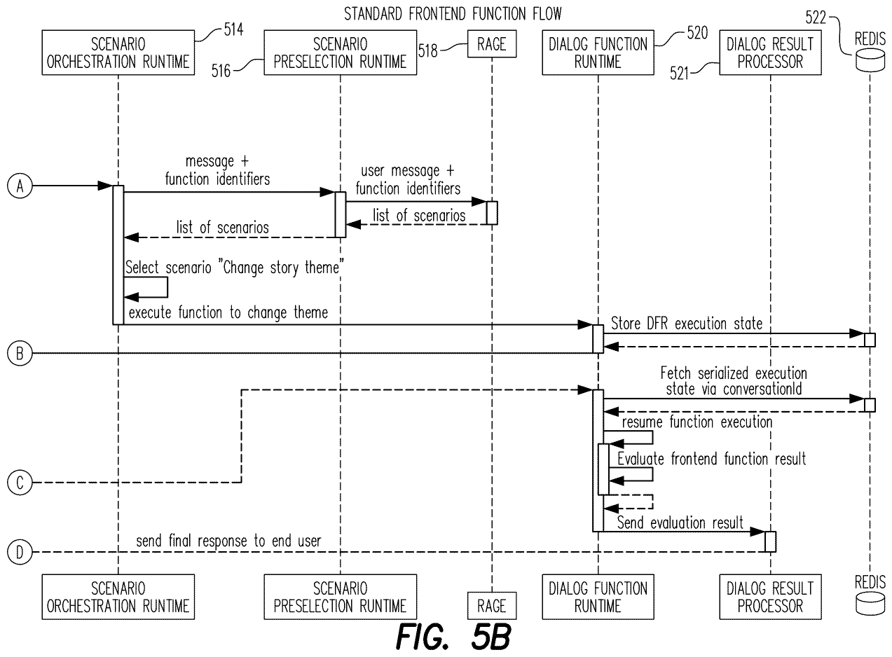

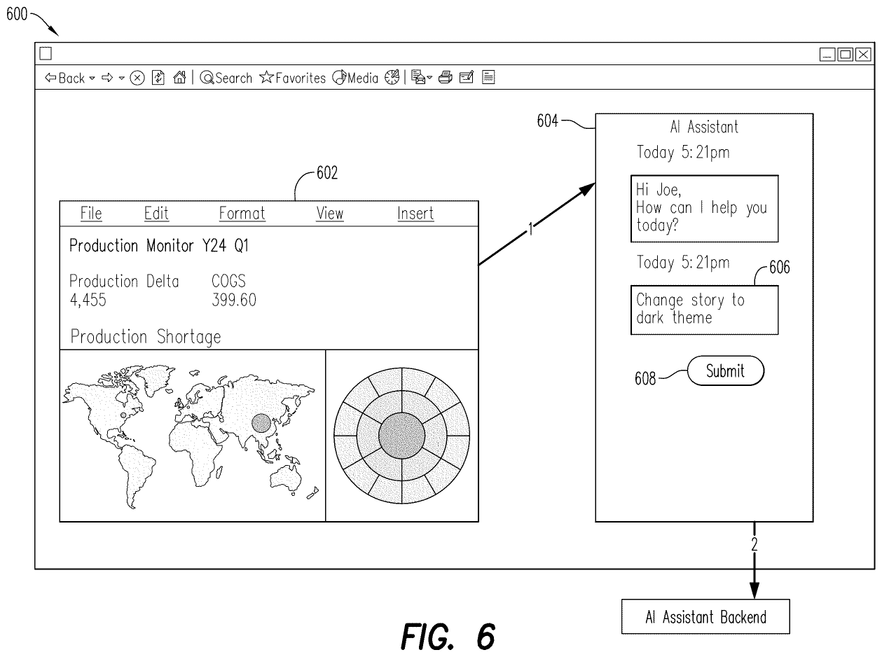

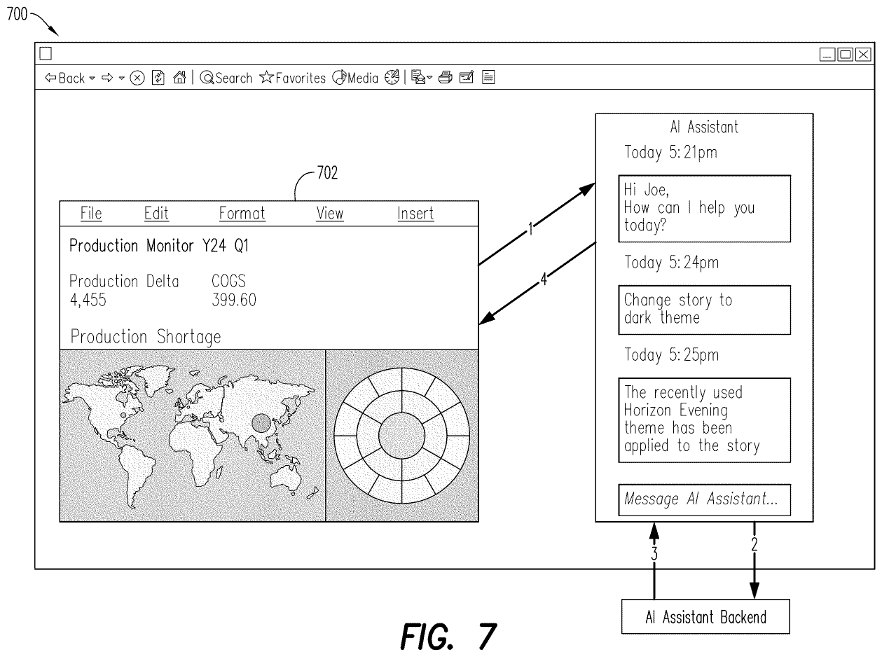

FIGS. 5A-7 relate to a user request to change a story theme to dark. FIGS. 5A and 5B are a sequence diagram 500 illustrating a change of the story theme to dark. FIGS. 6 and 7 are non-exhaustive examples of a user interface display including initiation of the request and a response to the request, respectively.

As illustrated in the sequence diagram 500 user device 502 calls the AIA Web Client 504 with a user query 506.

FIG. 6 is a non-exhaustive example of a user interface 600. The user interface 600 includes a running application UI 602 and an AIA Web Client 604. The running application UI displays text and images in a light background. The AIA Web Client 604 receives a request (“Change story to dark theme”) in area 606. In response to selection of the Submit icon 608, the user device 502 calls the AIA Web Client 504 with the user query.

The AIA Web Client 504 then transmits an application context data request to the running application 508, to extract application context data from the running application 508. The running application returns the application context data including the list of one or more application-specific frontend functions to the AIA Web Client 504 (at “1” in FIG. 6). The list of one or more application-specific frontend functions are a list of available functions for the current screen of the running application.

Next, (at “2” in FIG. 6), the AIA Web Client 504 transmits—via a client connector 510 and a bot runtime 512—the list of one or more application-specific frontend functions and the user query (“message”/“user message”) to the AI Assistant Backend including the Scenario Orchestration Runtime Engine 514 and the Scenario Pre-Selection Runtime Engine 516. The Scenario Pre-Selection Runtime Engine 516 transmits the user query and list of one or more application-specific frontend functions to the RAGE framework 518. As described above, the RAGE framework 518 returns a list of capabilities/scenarios to the Scenario Orchestration runtime engine 514 via the Scenario Pre-Selection Runtime Engine 516. The Scenario Orchestration Runtime Engine 514 then selects the capability (“change story theme”) from the list of capabilities based on a determination the requested functionality per the user request maps to the function included in the selected capability. The Scenario Orchestration Runtime Engine 514 transmits an instruction (e.g., executable command) to the Dialog Function Runtime Engine 520. When encountering a frontend function action (e.g., execution instruction) in the dialog function runtime, the dialog is a control that, via a Dialog Result Processor 521, interrupts/pauses the execution of other functions to call the frontend function. The Dialog Function Runtime (DFR) execution state is stored in a datastore 522 (e.g., Redis®). Following the pause, the Dialog Function Runtime Engine 520 transmits the executable command to execute the frontend function (e.g., in this case to change the story theme to dark) to the AIA Web Client 504 via the client connector (“3” in FIG. 6). Then, the AIA Web Client 504 transmits the executable command to the running Application 508. The running Application 508 executes the function to change the theme to dark. After successfully executing the function, the running Application 508 sends a response including an indication of completion of the execution (e.g., “success, new theme name”) to the Dialog Function Runtime Engine 520 via the AIA Web Client 504, and the Client Connector 510. The Dialog Function Runtime Engine 520 then fetches the serialized execution state—via conversation id—from the datastore 522, and resumes function execution. The Dialog Function Runtime Engine 520 next evaluates the frontend function result, and if appropriate (e.g., no errors), sends the final response to the end user device 502 (“4” in FIG. 6) via the Bot Runtime 512, Client Connector 510 and AIA Web Client 504. Here, the final response is the story having a dark theme per the application user interface 702, as shown in the display 700 of FIG. 7.

FIG. 8 illustrates a cloud-based database deployment 800 according to some embodiments. The illustrated components may reside in one or more public clouds providing self-service and immediate provisioning, autoscaling, security, compliance and identity management features.

User device 810 may interact with applications executing on the cloud server 820, for example via a Web Browser executing on user device 810, in order to execute a frontend function with an AI Assistant based on data managed by a database system 830. Database system 830 may store data as described herein and may execute processes as described herein. Cloud server 820 and database system 830 may comprise cloud-based compute resources, such as virtual machines, allocated by a public cloud provider. As such, cloud server 820 and database system 830 may be subjected to demand-based resource elasticity. Each of the user device 810, cloud server 820, and database system 830 may include a processing unit 835 that may include one or more processing devices each including one or more processing cores. In some examples, the processing unit 835 is a multicore processor or a plurality of multicore processors. Also, the processing unit 835 may be fixed or it may be reconfigurable. The processing unit 835 may control the components of any of the user device 810, cloud server 820, and database system 830. The storage devices 840 may not be limited to a particular storage device and may include any known memory device such as RAM, ROM, hard disk, and the like, and may or may not be included within a database system, a cloud environment, a web server or the like. The storage device 840 may store software modules or other instructions/executable code which can be executed by the processing unit 835 to perform the method shown in FIG. 2. According to various embodiments, the storage device 840 may include a data store having a plurality of tables, records, partitions and sub-partitions. The storage device 840 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A system comprising:
a memory storing program code: and
one or more processing units to execute the program code to cause the system to:
receive a request at an Artificial Intelligence (AI) assistant, the request received from a user of a remote device via a distributed communication network;
receive, from an application associated with the request, a list of one or more frontend functions;
select an AI Assistant capability based on the received request and the received list of one or more frontend functions;
generate, by the AI Assistant, an executable command including a listed frontend function for the application based on the selected AI Assistant capability and the received request; and
execute the executable command in response to receipt of the executable command by the application.

2. The system of claim 1, further comprising program code to cause the system to:
determine an AI Assistant function included in the selected AI Assistant capability maps to a first frontend function of the listed one or more frontend functions.

3. The system of claim 1, wherein the list of frontend functions are application-specific.

4. The system of claim 1, wherein the request is application-specific.

5. The system of claim 1, wherein the AI Assistant capability includes a description, required parameters and one or more linked AI Assistant functions.

6. The system of claim 1, further comprising program code to cause the system to:
detect, via the AI Assistant, the application associated with the request is executing next to the AI Assistant, wherein the detection is prior to receipt of the list of one or more frontend functions.

7. The system of claim 1, wherein the AI Assistant is a software program.

8. The system of claim 7, wherein execution of the selected AI Assistant capability further comprises program code to cause the system to:
execute, via the AI Assistant, a large language model (LLM) using the AI Assistant capability and request as input, wherein the executable command is output from execution of the LLM.

9. The system of claim 1, wherein the executable command includes one or more parameters and parameter values provided by a large language model (LLM).

10. The system of claim 1, wherein the frontend function is one of: a filter function, a refresh/reload data function, a navigation function, a populate data function, a select data function, a retrieve content function, an aggregate function, a summarize function, and a retrieve selected data function.

11. A computer-implemented method comprising:
receiving a request at an Artificial Intelligence (AI) assistant, the request received from a user of a remote device via a distributed communication network;
receiving, from an application associated with the request, a list of one or more application-specific frontend functions;
selecting an AI Assistant capability based on the received request and the received list of one or more application-specific frontend functions;
generating an executable command including a listed application-specific frontend function for the application based on the selected capability and the received request; and
executing the selected AI Assistant capability at the application in response to receipt by the application of the executable command.

12. The computer-implemented method of claim 11, further comprising:
determining an AI Assistant function included in the selected AI Assistant capability maps to a first frontend function of the listed one or more application-specific frontend functions.

13. The computer-implemented method of claim 11, further comprising:
detecting the application associated with the request is executing next to the AI Assistant, wherein the detection is prior to receipt of the list of one or more application-specific frontend functions.

14. The computer-implemented method of claim 11, wherein the AI Assistant capability includes a description, required parameters and one or more linked AI Assistant functions.

15. The computer-implemented method of claim 11, wherein execution of the selected AI Assistant capability further comprises:
executing a large language model (LLM) using the AI Assistant capability and request as input, wherein the executable command is output from execution of the LLM.

16. The computer-implemented method of claim 11, wherein execution of the selected AI Assistant capability further comprises:
executing, via the AI Assistant, a large language model (LLM) using the AI Assistant capability and request as input, wherein the executable command is output from execution of the LLM.

17. One or more non-transitory, computer-readable medium storing instructions, that, when executed by a computing system, cause the computing system to perform operations comprising:
receiving a request at an Artificial Intelligence (AI) assistant, the request received from a user of a remote device via a distributed communication network;
receiving, from an application associated with the request, a list of one or more application-specific frontend functions;
selecting an AI Assistant capability based on the received request and the received list of one or more application-specific frontend functions;
generating an executable command including a listed application-specific frontend function for the application based on the selected capability and the received request; and
executing the selected AI Assistant capability at the application in response to receipt by the application of the executable command.

18. The medium of claim 17, wherein the AI Assistant capability includes a description, required parameters and one or more linked AI Assistant functions.

19. The medium of claim 17, wherein execution of the selected AI Assistant capability further comprises:
executing, via the AI Assistant, a large language model (LLM) using the AI Assistant capability and request as input, wherein the executable command is output from execution of the LLM.

20. The medium of claim 17, wherein the executable command includes one or more parameters and parameter values provided by a large language model (LLM).
